(19) United States
(12) Patent Application Publication
(10) Pub. No.: US 2026/0357893 A1
(43) Pub. Date: Nov. 12, 2026

(54) A PARK LOCK SYSTEM FOR VEHICLES

(71) Applicant: Stellantis e-Transmissions NV, Brussels (BE)

(72) Inventor: Peter Mark SMID, Brussels (BE)

(21) Appl. No.: 19/130,665

(22) PCT Filed: Nov. 17, 2023
(86) PCT No.: PCT/EP2023/082189

§ 371 Date: May 16, 2025

(30) Foreign Application Priority Data
Nov. 17, 2022 (BE) BE2022/5931

(51) Int. Cl. F16H 63/34

(52) U.S. Cl. CPC F16H 63/3425

(57) ABSTRACT

The present disclosure envisages a park lock system 100 for vehicle. The park lock system (100) includes two park pawls viz. A first park pawl (102a) and a second park pawl (102b). The two park pawls (102a and 102b) are strategically positioned to reduce the backlash/rolling of vehicle wheel after the vehicle is switched into a park mode. The arrangement is such that the only one locking-element (104a or 104b) of the park pawls (102a, 102b) will be able to engage with park gear (110) when the park lock system (100) is switched to parked mode. When in assembled condition, the distance between the locking-elements (104a and 104b) is different than the distance between adjacent tooth-spaces (110a) (and/or its multiple) defined on the park gear (110). The advantage of the park lock system (100) is that, the backlash seen on wheels after parking is drastically reduced.

### FIELD OF INVENTION

The present disclosure relates to the field of automobiles. More particularly, the present disclosure relates to the field of park lock system for automobiles/vehicles.

### DEFINITION

The below mentioned terms will carry the stated meaning in relation to the present disclosure.

Arming an actuation rod: The term ‘arming of actuation rod’ refers to the action of pushing the actuation rod and wedging element towards the pawl, such that the wedging element pushes the pawl towards park gear and the lock element of the pawl engages with a tooth-space of the park gear as soon as any adjacent tooth-space comes in a position suitable for receiving the locking-element.

Un-arming an actuation rod: The term ‘un-arming an actuation rod’ refers to the action of pulling back the actuation rod and wedging element away from the pawl, such that the pawl moves away from the park gear to terminate the engagement between locking-element and tooth-space of the park gear.

### BACKGROUND

Conventionally, a hand brake is used to put a car, or a vehicle is parking mode to keep the vehicle securely motionless when parked (or at the will of the driver). The vehicles may include conventional vehicles, Battery Electric Vehicles (BEV), Pure Electric Vehicles (PEV), Hybrid Electric Vehicles (HEV), or Plug-in Hybrid Electric Vehicles (PHEV).

Presently, vehicle owners and government bodies are increasingly concerned about passenger and vehicle safety not only while driving the vehicle but also when the vehicle is parked or is in a neutral gear. In some modern vehicles, park lock systems are being used to immobilize the vehicle by engaging a park pawl with a park gear or any other feature provided on transmission system of the vehicle. However, there is always some backlash (small amount of wheel role/movement) even after the vehicle is switched to a parked mode. This happens, since there is some play between the park pawl and the park gear, which leads to a certain undesirable role/movement of the vehicle before there is a positive engagement between the park pawl and the park gear.

To solve the above-mentioned drawbacks, there is a dire need to develop a park lock system that overcomes the above-mentioned shortcomings of presently known park locks.

### OBJECTS

Some of the objects of the present disclosure, which at least one embodiment herein satisfies, are as follows:

An objective of the present disclosure is to provide a park lock system for vehicles.

An objective of the present disclosure is to provide a park lock system for vehicles, wherein the backlash in the park lock, park gear, and vehicle wheels is reduced.

Another objective of the present disclosure is to provide a park lock system for vehicles, wherein each pawl of the park lock can be individually and independently engaged with the park gear.

Yet another objective of the present disclosure is to provide a park lock system for vehicles, wherein the park lock system is easy to operate.

### SUMMARY OF THE INVENTION

The present disclosure envisages a park lock system for vehicle. The park lock system of the present disclosure overcomes the drawbacks faced in the systems available in the market. The park lock system of the present disclosure uses two park pawls which have their locking-elements spaced apart such that only one of the two park pawls can engage with a park gear at any given instance, when the vehicle is switched to a parked mode.

The park lock system comprises a first park pawl pivotally mounted on a support wherein the first park pawl is configured to move between a parked position and an unparked position; a second park pawl pivotally mounted on a support adjacent to the first park pawl wherein the second park pawl configured to move between a parked position and an unparked position; a park gear provided in the transmission system of the vehicle wherein the park gear is configured to engage with either of the two park pawls to lock the movement of the vehicle when in a parked mode. The system further includes a pawl-head with a pawl-head-profiles defined at the corresponding operative front ends of the two park pawls, an actuation rod configured to push a wedging-element over the pawl-head-profiles of the corresponding pawl-head, to push corresponding pawls towards their parked/actuated positions; and an actuation means configured to arm and/or unarm the actuation rods between the actuated and unactuated position, upon receiving command signal related to parked and unparked mode from a control unit. When the park lock system is switched to a parked mode, either of the two park pawls is engaged with the park gear to restrict the movement of the vehicle.

The actuation means can be selected from the group consisting of hydraulic pistons, pneumatic pistons, mechanical levers, mechanical switches, electro-mechanical switches, and solenoid.

The orientations of the pawls may be mirrored to each other or are parallel to one another, when in assembled condition.

The distance between locking-element of the first park pawl and locking-element of the second park pawl may be not equal to one or more pitch distances of the park gear, when in assembled condition.

Additionally and/or alternatively, a plurality of tooth-spaces can be defined on the park gear, wherein each of the tooth-space can be configured to receive the closest locking-element of the two park pawls.

Advantageously, the first park pawl may be configured to prevent the rotation of the park gear in first and second rotary direction by means of a form-closed locking and the second park pawl is also configured to prevent the rotation of the park gear in the first and second rotary direction by means of a form-closed locking. The first and second park pawls may be positioned such that only one of the pawls can engage with a tooth-space of the park gear.

Further, a wedging-element may be assembled at the operative front end of each of the actuation rods.

In an example, a first compression spring can be provided on each actuation rod to maintain the actuation rod biased towards the respective pawl, while a second compression spring can be configured to abut a plate at the operative rear end of the actuation rods, and a third compression spring can be configured to act as an arming spring is provided between the wedging-element and the operative front end of each of the actuation rods for maintaining an arming force on the pawl profiles to push the pawls towards the park gear, when the park lock system is in parked mode.

Additionally and/or alternatively, a return-spring can be connected to each of the pawls to bias the pawls towards their unactuated positions. The park position actuation means can be operated manually or upon receiving signals from a controller.

Also, an override pin and a solenoid may be provided to restrict and lock the travel of the actuation rod on receiving a command from the user or control unit.

Further, a park sensor can be provided in proximity to the actuation rods to detect the position of the actuation rods.

According to an aspect, the present disclosure also includes a vehicle including a park lock system as disclosed above.

According to another aspect, the present disclosure describes a method of operating a park lock system. The method comprises the following steps:
actuating an actuation means on receiving a signal from a control or a manual switch when the vehicle is switched to a parking mode;
arming of actuation rods by the actuation means towards respective park pawl;
the park pawl biased by respective actuation rods towards a park gear;
a locking-element of either of the park pawls engaging with a tooth-space defined on the park gear,
   such that the engagement of the locking-elements with the park gear restricts the rotation of the transmission and wheels of vehicle.

### BRIEF DESCRIPTION OF THE ACCOMPANYING DRAWING

Same reference numerals refer to same elements or elements of similar function throughout the various figures. Furthermore, only reference numerals necessary for the description of the respective figure are shown in the figures. The shown embodiments represent only examples of how the invention can be carried out. This should not be construed as a limitation of the invention.

For a better understanding of the invention, and to show more clearly how it may be carried into effect, reference will now be made, by way of example only, to the accompanying drawings.

FIG. 1 shows a schematic view of a conventional park lock system.

FIG. 2a shows a schematic side view of a park lock system for vehicle, when in a parked mode, in accordance with an embodiment of the present invention.

FIG. 2b shows a schematic top view of the park lock system of FIG. 2a.

FIG. 3a shows a schematic side view of a park lock system for vehicle, when in an unparked mode, in accordance with an embodiment of the present invention.

FIG. 3b shows a schematic top view of the park lock system of FIG. 3a.

FIG. 3c shows a cut section view of the operative front end of the actuation rod along a plane A-A as shown in FIG. 3b.

FIG. 4 shows a schematic view of a first set of pawls, actuation rod, and wedging-element in the park lock system, in accordance with another embodiment of the present invention.

FIG. 5 shows a schematic view of a second set of pawls, actuation rod, and wedging-element in the park lock system.

### LIST OF REFERENCE NUMERALS

3—Actuator
5—Park gear
5a—Slot in park gear
9—Actuation rod
11—Slider
13—Park pawl
15—Arming spring
17—Override pin & solenoid
100—Park lock system
110—Park gear
102a—First park pawl
102b—Second park pawl
103a—First park pawl actuation-body
103b—Second park pawl actuation-body
104a, 104b—Locking-element
105—Base element
110—Park gear
110a—Tooth-space
s1, s2—Spring(s)
s3—Arming spring
112—Actuation means
114—Return-spring
117a, 117b—Pawl-head-profiles
118—Wedging-element
120—Override pin
122—Solenoid
126—Park sensor
130a, 130b—Actuation rod
132—Actuation-head-profile

### DETAILED DESCRIPTION

Same reference numerals refer to same elements or elements of similar function throughout the various figures. Furthermore, only reference numerals necessary for the description of the respective figure are shown in the figures. The shown embodiments represent only examples of how the invention can be carried out. This should not be construed as a limitation of the invention. It is noted that figures and drawings may not be to scale.

In some embodiments, well-known processes, well-known apparatus structures, and well-known techniques are not described in detail as the same are known to the person skilled in the art.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise.

For a better understanding of the invention, and to show more clearly how it may be carried into effect, reference will now be made, by way of example only, to the accompanying drawings.

Terms such as first, second, third etc., (used to distinguish one element, component, region, layer or section from another component, region, layer or section) when used herein do not imply a specific sequence or order unless clearly suggested by the present disclosure.

The present invention discloses a park lock system 100 for vehicles.

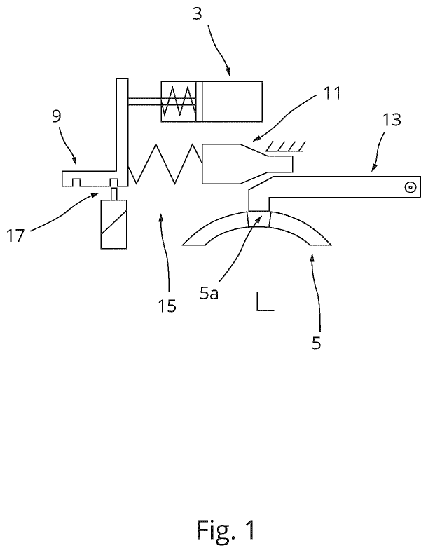

FIG. 1 illustrates the principle of working of the park lock system 100. As seen in FIG. 1, an actuator 3 in the form of a piston cylinder arrangement is used to displace an actuation rod 9. The actuation rod 9 is connected to a slider 11 via an arming spring 15. A park pawl 13 is pivotally mounted and is configured to co-operate with the slider 11 to move between locked and unlocked position. The operative front end of the park pawl 13 engages with a slot 5a provided on park gear 5. An override pin & solenoid 17 is provided to limit the travel of the actuation rod 9 beyond predefined positions.

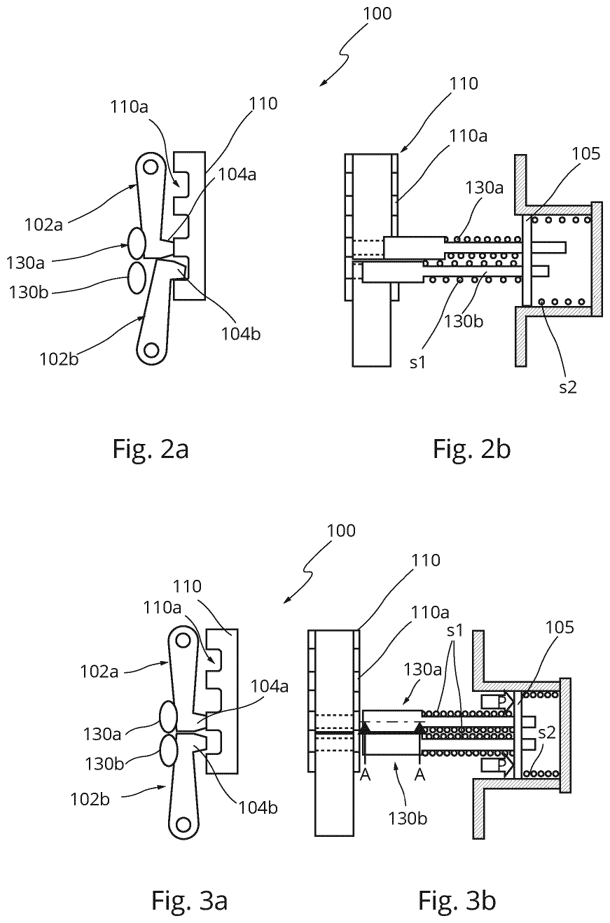

FIGS. 2a to 5 show the park lock system 100, in accordance with different embodiments of the present disclosure. Any obvious addition and modification of the system 100 is to be considered within the scope of the present invention.

FIGS. 2a-2b show the park lock system 100 in a parked mode. The mode of the park lock system 100 can be switched either manually or automatically upon receiving signal from a control unit. The control unit can be a dedicated controller with an inbuilt processor or an ECU (electronic control unit) of the vehicle.

The park lock system 100 of the present disclosure comprises a first park pawl 102a, a second park pawl 102b, a first actuator rod 130a, a second actuator rod 130b, a park gear 110, and elastic elements in the form of springs (s1, s2, s3). For avoiding repetition of terms both the first and the second actuation rod (130a and 130b) may be sometimes collectively referred to as actuation rod 130. A return-spring 114 provided on each of said park pawls (102a, 102b) to bias said park pawls towards their unactuated positions. A locking-element (104a, 104b) is defined near the free ends of the respective park pawls (102a, 102b), wherein the locking-element (104a, 104b) are configured to releasably engage with the park gear 110. The park gear 110 is fastened to the transmission assembly. A plurality of tooth-spaces 110a is defined on the park gear 110. The park pawls 102a and 102b are pivotally mounted. When in assembled condition, the distance between the locking-elements (104a and 104b) is different than (not equal to) the distance between the adjacent tooth-spaces 110a (pitch) and the multiple of the tooth-space distance of the park gear 110.

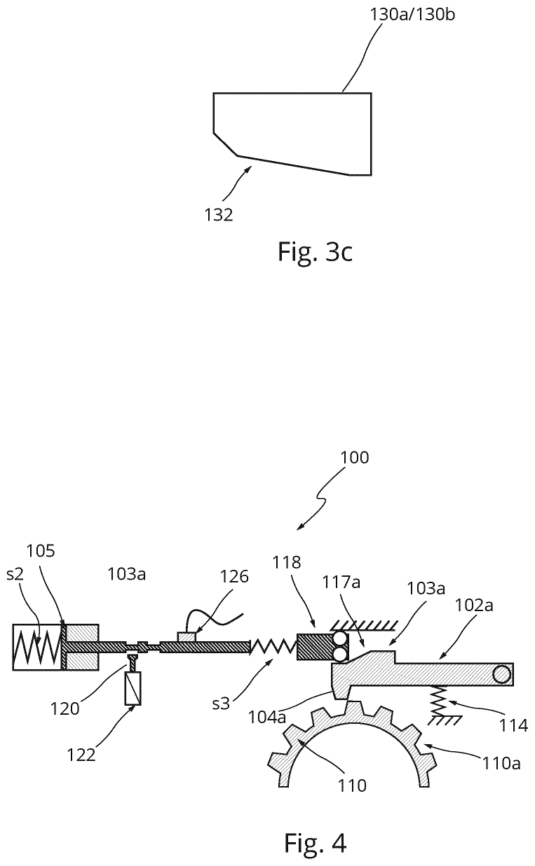

A contour or a curved profile is defined on the contact surfaces between the park pawls and the actuation rods. According to one embodiment of the present invention, the actuation-head-profile 132 is provided near the operative front end of each of the actuation rods (130a, 130b), as seen in FIG. 3c. FIG. 3c shows a cut section view of the operative front ends of the actuation rods with actuation-head-profile 132 defined, thereon.

Whenever, the actuation rods move relative to the park pawls, the interaction between the contact surfaces results in the resolution and distribution of forces which either results in the shifting of the park pawl towards the park gear 110 or away from the park gear 110.

Parked mode: (Refer to FIG. 2a-2b) The park pawls 102a and 102b are normally biased away from the park gear 110 by virtue of the force of a return-spring (not seen in FIGS. 2a-2b). However, the spring s2 alone and/or in co-operation with springs s1 apply force on each of the actuation rods (130a and 130b), so as to push the actuation rods towards the park pawls (102a and 102b). When the vehicle is in parked mode, the combined force of the springs s1 and/or s2 is enough to overcome the force from the return-spring 114. As a result, the park pawls 102a and 102b are pushed towards the park gear 110, and then either of the two locking-elements 104a or 104b enters into a tooth-space 110a to restrict the movement of the park gear and the vehicle.

Unparked mode: An actuation means (not specifically shown in figures) is configured to exert the necessary motive force to change the state of the park lock system 100 from a parked mode to an unparked mode, and vice-a-versa. The actuation means is selected from the group consisting of hydraulic pistons, pneumatic pistons, mechanical switches, mechanical levers, electro-mechanical switches, and solenoid.

FIGS. 3a-3b shows the park lock system 100 in an unparked mode, wherein both the park pawls are in the retracted positions. As seen in FIG. 3b, the actuation means exerts a force P on plate 105 which compresses spring s2. As a result, the actuation rods (130a, 130b) are retracted away from the park pawls 102a, 102b. In some cases, the force P can directly be applied on the actuation rods instead of the plate 105. The main principle of switching the system 100 to unparked mode is to reduce the net force acting on the actuation rods that try to keep the actuation rods pressed against the park pawls. With the reduction/removal of the contact force between the actuation rods and the respective park pawls, the return-springs pushes the park pawls 102a, 102b away from the park gear 110.

The vehicle can be turned to unparked mode when a user presses a lever, a switch, or a button. The same can be achieved automatically via a controller when a predefined condition is achieved.

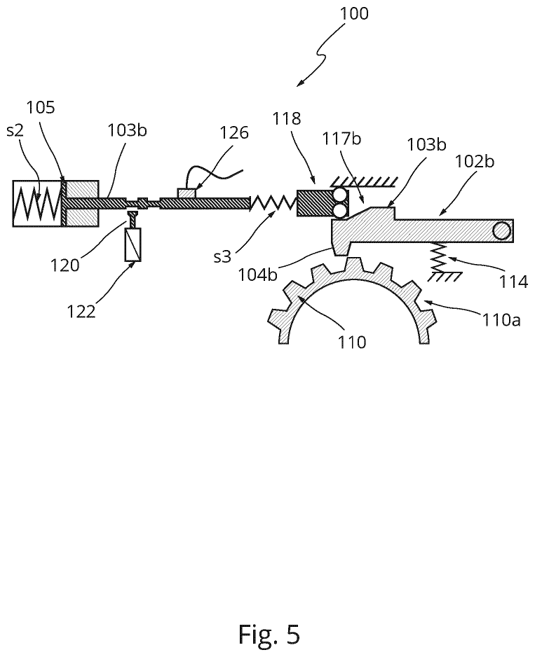

FIGS. 4-5 show a park lock system in accordance with another embodiment. The basic principle of operation remains the same. Instead of defining an actuation-head-profile 132 on the actuation rods (130a, 130b) as seen FIGS. 2a-3c, the pawl-heads (103a, 103b) are provided with pawl-head-profiles (117a, 117b). A wedging-element 118 is assembled at the operative front end of each of the actuation rods (130a, 130b). A compression spring s3 is sandwiched between the corresponding wedging-element 118 and the operative front end of each actuation rod (130a, 130b). A locking-element (104a, 104b) is defined on the corresponding/respective pawl-head (103a, 103b). The wedging-element 118 can be a sliding element, a cone, or a roller-cage. The selection of sliding element or a roller-cage will depend on packaging constraint and operational feasibility.

FIGS. 4 and 5 show the park lock system 100 when in unparked mode. The plate 105 (piston) is pushed towards the left side by the fluid pressure and is held at the same position until the vehicle is moving or until the user switches the vehicle into the parked mode.

Parked mode: To turn the park lock system 100 of FIG. 4 into a parked mode, either the user has to switch the park mode manually or the control unit automatically activate the parked mode when the engine of the vehicle is turned off. For EVs the condition to activate the parked mode may be dependent on the vehicle speed, gear selection or vehicle-key-switch position. Once the parked mode is activated the fluid pressure on the plate 105 is reduced and the actuation rod 130a moves to the right under the action of the forces from springs s2 and s3. The wedging-element 118 is pressed on the pawl-head-profile 117a. Due to the shape of the pawl-head-profile 117a the forces are resolved and the park pawl 102a is pressed towards the park gear 110. The locking-element 104a will be biased towards the park gear 110 and if the tooth-space 110a is just at the perfect receiving position to receive the locking-element 104a there will be immediate engagement, therebetween. In case, at the instant, the tooth-space 110a is slightly offset, the locking-element 104a will engage with an adjacent tooth-space 110a which comes in the receiving position.

Similarly, the operation of the second park pawl 102b and the second actuator 130b can be illustrated using FIG. 5.

The first park pawl 102a is pivotally mounted on a support while the second park pawl 102b is pivotally mounted on a support adjacent to the first park pawl 102a.

The park gear 110 is provided in the transmission system of the vehicle and configured to co-operate/engage with either of the first park pawl 102a and the second park pawl 102b, to lock the movement of the vehicle when the vehicle is switched to the parked mode. The pawl-heads (103a, 103b) with pawl-head-profiles (117a, 117b) are defined at the respective operative front ends of the pawls (102a, 102b).

The actuation means is configured to arm/unarm the actuation rod (130a, 130b) between the actuated and unactuated positions, upon receiving commands related to parking mode.

Orientation-I of park pawls: In an embodiment, the orientation of the first park pawl 102a is mirrored with respect to the second park pawl 102b, when both are assembled. The placement and orientation of the park pawls can be changed as per the packaging and space constraints and shall be considered within the scope of the present invention.

Orientation-II of park pawls: In another embodiment, the first park pawl 102a is pivoted about same pivot point and their free ends are extending on the same side.

Orientation-III of park pawls: In another embodiment, the first park pawl 102a is pivoted about same pivot point while their free ends are extending on opposite direction.

In the above-mentioned orientations, the locking-elements 104a, 104b of both the park pawls 102a, 102b will be pointing towards the park gear 110 while the actuation rods 130a, 130b will be suitably placed to enable the working of the park lock system 100 in accordance with the present invention.

According to an aspect of the present disclosure, the first park pawl 102a is configured to prevent the rotation of park gear 110 in first and second rotary direction by means of a form-closed locking. The second park pawl 102b is configured to prevent the rotation of said park gear 110 in first and second rotary direction by means of a form-closed locking.

The first and second park pawl (102a, 102b) is positioned such that one of the pawls will engage the park gear 110 first while rotating the park gear 110. Further, the first and second park pawl (102a and 102b) are positioned such that first and second park pawls (102a, 102b) cannot engage with the park gear 110 at the same time.

The first compression spring (s1) is provided on each actuation rod to maintain the actuation rods (130a, 130b) biased towards the respective park pawl. The second compression spring (s2) is configured to abut the plate 105 supporting the actuation rods (130a, 130b).

The park gear 110 may also be fastened on drive shaft of the prime mover of the vehicle.

In an example, an override pin 120 and solenoid 122 is provided near the actuation rod to restrict the travel of the actuation rods (130a, 130b). When the vehicle is in break-down condition the driver or service personal can either keep the vehicle in unparked mode so as to facilitate towing of the vehicle. Also, in some cases if the vehicle fails to automatically switch to a parked mode after turning off the ignition, the drive may use an override switch to manually turn the vehicle into the parked mode, to prevent rolling of the vehicle. The override pin 120 engages with slots provided on the actuation rods 130a, 130b.

A park sensor 126 is provided in proximity to the actuation rods (130a, 130b) to detect the position of the actuation rods.

When the actuation means is activated, and the vehicle is switched to unparked mode the plate 105 (or piston) is pushed against the larger spring s2. As a result, both the park pawls 102a, 102b are retracted away from the surface of the park gear 110 by virtue of the force of the return-spring 114. This ensures that the vehicle remains in an unparked mode as long as the actuation means is directly or indirectly pushing the actuation rods (130a and 130b) aways from the park pawls (102a and 102b).

Due to the arrangement of the park pawls only one of the two park pawls 102a, 102b will positively engage with a tooth or the tooth-space 110a defined on the park gear 110.

In a preferred embodiment, the plate 105 (or piston) is moved by hydraulic force. Further, other type of motive forces can also be used as per convenience. For example, solenoids, cables, electro-mechanical, pneumatic force can be used to operate the plate 105 (or piston). When the external force on the plate 105 (and the actuation rods 130a, 130b) is removed, the system 100 and the vehicle goes back to a parked mode.

The spacing between the adjacent grooves on the park gear 110 and that between the locking-elements 104a, 104b of the park pawl 102a, 102b is maintained such as to ensure that only one park pawl 102a/102b can engage with the park gear 110.

FIG. 5 shows a schematic view of the park lock system 100, when the vehicle is in unparked/unarmed mode. In this state the actuator rod (130a, 130b) and the wedging-element 118 is in a retracted position. As a result, the park pawl 102a is disengaged from the park gear 110.

The method of operating the park lock system 100 of the present disclosure includes the following steps. Initially, the park pawls (102a, 102b) are not engaged with the park gear 110. When the park lock system 100 receives a signal after drivers cabin or from a controller, the actuation means is actuated to arm (activate) the actuation rods (130a and 130b) towards the respective park pawl (102a and 102b). The actuation rod either directly or indirectly exerts a force of the park pawl (102a, 102b) such that the pawls tend to moves towards the park gear 110. The locking-elements (104a, 104b) of the park pawls (102a, 102b) are pressed against the park gear 110. A locking-element (104a, 104b) of either of the park pawls (102a, 102b) gets engaged with the tooth-space 110a defined on the park gear 110. The engagement of the locking-element (104a or 104b) with the park gear 110 restricts the rotation of the transmission system and the wheels of the vehicle. The order of operation is reversed when the park system is switched to unparked mode. The locking-element 104a or 104b retracts from the tooth-space 110a and the vehicle is free to move.

The advantage of the park lock system 100 is that the backlash seen on wheels after parking will be significantly reduced. This is especially effective for park lock systems which are located on the differential, since they usually have larger rollback distances which could lead to bad user experience and may attract customer complaints.

The park lock system 100 of the present invention is compact, quick in response, efficiently packed, and economical.

The foregoing description of the embodiments has been provided for purposes of illustration and not intended to limit the scope of the present disclosure. Individual components of a particular embodiment are generally not limited to that embodiment but are interchangeable. Such variations are not to be regarded as a departure from the present disclosure, and all such modifications are within the scope of the present disclosure.

### Technical Advancements

The present disclosure described herein above has several technical advantages including, but not limited to, the realization of a park lock system for vehicles that:
reduces the backlash in the park lock system;
is reliable;
is quick in operation;
is easy to assemble;
is compact in size and meets the packaging constraints; and
is more robust.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments to fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

For the purpose of clarity and a concise description, features are described herein as part of the same or separate embodiments, however, it will be appreciated that the scope of the invention may include embodiments having combinations of all or some of the features described. It may be understood that the embodiments shown have the same or similar components, apart from where they are described as being different.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1: A park lock system for vehicles, said park lock system comprising:
a first park pawl pivotally mounted on a support, said first park pawl configured to move between a parked position and an unparked position;
a second park pawl pivotally mounted on a support adjacent to said first park pawl, said second park pawl configured to move between a parked position and an unparked position;
a park gear provided in the transmission system of the vehicle, said park gear configured to engage with either of said park pawls, to lock the movement of the vehicle when in a parked mode;
a pawl-head with a pawl-head-profiles defined at the corresponding operative front ends of said park pawls; an actuation rod configured to push a wedging-element over said pawl-head-profiles of corresponding pawl-head, to push corresponding pawls towards their parked/actuated positions; and
an actuation means configured to arm and/or unarm said actuation rods between the actuated and unactuated position, upon receiving command signal related to parked and unparked mode from a control unit,
when said park lock system is switched to a parked mode, either of said park pawls is engaged with said park gear, to restrict the movement of the vehicle.

2: The park lock system for vehicles as claimed in claim 1, wherein said actuation means is selected from the group consisting of hydraulic pistons, pneumatic pistons, mechanical levers, mechanical switches, electro-mechanical switches, and solenoid.

3: The park lock system for vehicles as claimed in claim 1, wherein the orientations of said park pawls are mirrored to each other or are parallel to one another, when in assembled condition.

4: The park lock system for vehicles as claimed in claim 1, wherein the distance between locking-element of said first park pawl and locking-element of said second park pawl is not equal to one or more pitch distances of said park gear, when in assembled condition.

5: The park lock system for vehicles as claimed in claim 1, wherein a plurality of tooth-spaces is defined on said park gear, each of said tooth-space is configured to receive locking-element of the closest park pawl.

6: The park lock system for vehicles as claimed in claim 1, wherein
said first park pawl is configured to prevent the rotation of park gear in first and second rotary direction by means of a form-closed locking;
said second park pawl is configured to prevent the rotation of said park gear in first and second rotary direction by means of a form-closed locking; and
said first and second park pawls are positioned such that only one of said park pawls can engage with a tooth-space of said park gear.

7: The park lock system for vehicles as claimed in claim 1, wherein a wedging-element is assembled at the operative front end of said actuation rod.

8: The park lock system (100) for vehicles as claimed in claim 1, wherein:
a first compression spring is provided on each actuation rod to maintain the actuation rod biased towards the respective pawl;
a second compression spring configured to abut a plate at the operative rear end of said actuation rods; and
a third compression spring configured to act as an arming spring is provided between said wedging-element and the operative front end of each of said actuation rods for maintaining an arming force on said pawl-head-profiles, to push said park pawls towards the park gear, when in parked mode.

9: The park lock system for vehicles as claimed in claim 1, said system includes a return-spring provided on each of said park pawls to bias said park pawls towards their unactuated positions.

10: The park lock system for vehicles as claimed in claim 1, wherein said park position actuation means is configured to be operated manually or upon receiving signals from a controller.

11: The park lock system for vehicles as claimed in claim 1, wherein an override pin and a solenoid is provided to restrict and lock the travel of the actuation rod on receiving a command from the user.

12: The park lock system for vehicles as claimed in claim 1, wherein a park sensor is provided in proximity to said actuation rods to detect the position of said actuation rods.

13: A vehicle including the park lock system as claimed in claim 1.

14: A method of operating a park lock system, said method comprising the following steps:
actuating an actuation means on receiving a signal from a control or a manual switch when the vehicle is switched to a parking mode;
actuation rods armed by said actuation means towards respective park pawl;
said park pawls biased by respective actuation rods towards a park gear; and
a locking-element of either of said park pawls engaging with a tooth-space defined on said park gear,
the engagement of said locking-elements with said park gear restricting the rotation of transmission and wheels of vehicle.

15: The park lock system as claimed in claim 1, wherein said wedging-element is selected from the group consisting of a sliding element, a cone, and a roller-cage.

16: The vehicle as claimed in claim 13, wherein said wedging-element is selected from the group consisting of a sliding element, a cone, and a roller-cage.
